(19) United States
(12) Patent Application Publication
(10) Pub. No.: US 2024/0255963 A1
(43) Pub. Date: Aug. 1, 2024

(54) VEHICLE UNLOADING MANAGEMENT DEVICE AND VEHICLE UNLOADING MANAGEMENT METHOD

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Tatsuya Sugano, Sunto-gun Shizuoka-ken (JP); Ryuji Okamura, Gotemba-shi Shizuoka-ken (JP); Noriyuki Tsuruoka, Susono-shi Shizuoka-ken (JP); Daisuke Kakuma, Susono-shi Shizuoka-ken (JP)

(73) Assignee: TOYOTA JIDOSHA KABUSHIKI KAISHA, Toyota-shi Aichi-ken (JP)

(21) Appl. No.: 18/544,669

(22) Filed: Dec. 19, 2023

(30) Foreign Application Priority Data
Feb. 1, 2023 (JP) 2023-014241

(51) Int. Cl. G05D 1/667; G05D 105/20; G05D 107/80

(52) U.S. Cl. CPC G05D 1/667; G05D 2105/20; G05D 2107/85

(57) ABSTRACT

A vehicle unloading management device includes a processor. When an unload request for unloading a vehicle being loaded in an airport parking lot is received from a passenger of an airplane whose arrival destination is an airport, the processor sets a time period for performing automated unload of the passenger's vehicle. In the process of setting the time period, when at least two unload requests are received from at least two vehicles and time periods for performing automated unload of the at least two vehicles overlap, the processor predicts an arrival order at the airport parking lot of a passengers corresponding to the at least two unload requests with overlapping the time periods. And the processor determines an order for automated unload of the at least two vehicles according to the arrival order.

### CROSS-REFERENCE TO RELATED APPLICATION

The present application claims priority under 35 U.S.C. § 119 to Japanese Patent Application No. 2023-014241, filed on Feb. 1, 2023, the contents of which application are incorporated herein by reference in their entirety.

### BACKGROUND

### Technical Field

The present disclosure relates to a device and a method for managing an unload of an automated parking vehicle.

### Background Art

JP 2017111767 A discloses a technique to manage an unload gate for each vehicle unloading from a parking lot. In the related art, when a vehicle is unloaded from the unload gate, whether or not the vehicle is ready to be unloaded is determined based on priority information. If the vehicle is determined to be ready for unload, the unload gate is released.

### SUMMARY

Consider an airport parking lot. Users of this airport parking lot are expected to be users of the airport. The users of this airport parking lot include passengers of an airplane departing from the airport or arriving at the airport. Consider a case where some of the passengers on the airplane arriving at the airport are the user of the parking lot. In this case, when these users try to unload his/her vehicles at the same time period, unload process of the vehicles is concentrated.

Therefore, when the passengers of the same airplane are users of the same airport parking lot, and when unload reservations (unload requests) for vehicles are received from these users at the same time period, unload processing is considered to be performed according to the order of unload requests. In this case, a vehicle of the user who is late in getting off a certain airplane can be unloaded before a vehicle of the user who is early in getting off the airplane. Alternatively, the vehicle of the user who has a schedule other than the unload of the vehicle, such as picking up a baggage after getting off a certain airplane, can be unload before a vehicle of the user who does not have such a schedule. Therefore, a method of performing the unload processing according to the order of the unload requests may cause users' vehicles to remain at getting on/off area of the airport parking lot.

An object of the present disclosure is to provide a technique capable of avoiding a situation in which users' vehicles remains staying at getting on/off area of the airport parking lot, when some of the passengers of an airplane arriving at the airport are users of the same airport parking lot and unload requests for unloading vehicles of these users at the same time period.

A first aspect relates to a vehicle unloading management device for managing an unload of a vehicle parked in an airport parking lot. The vehicle unloading management device includes a processor. When an unload request for unloading a vehicle being loaded in the airport parking lot is received from a passenger of an airplane whose arrival destination is the airport, the processor sets a time period for performing automated unload of the passenger's vehicle. In the process of setting the time period, when at least two unload requests are received from at least two vehicles and time periods for performing automatic unload of the at least two vehicles overlap, the processor predicts an arrival order at the airport parking lot of passengers corresponding to the at least two unload requests with overlapping the time periods. And the processor determines an order for automated unload of the at least two vehicles according to the arrival order.

A second aspect relates to a vehicle unloading management method for managing an unload of a vehicle parked in an airport parking lot. The vehicle unloading management method includes:
when an unload request for unloading a vehicle being loaded in the airport parking lot is received from a passenger of an airplane whose arrival destination is the airport, setting a time period for performing automated unload of the passenger's vehicle;
in the process of setting the time period, when at least two unload requests are received from at least two vehicles and time periods for performing automated unload of the at least two vehicles overlap, predicting an arrival order at the airport parking lot of passengers corresponding to the at least two unload requests with overlapping the time periods; and
determining an order for automated unload of the at least two vehicles according to the arrival order.

According to the present disclosure, when the unload request is received from at least two vehicles and time periods for performing automatic unload of the at least two vehicles overlap, an order in which passengers corresponding to these vehicles unload requests are expected to arrive at the airport parking lot. Then, according to this arrival order, the order in which two or more vehicles are automatically unloaded is determined. Thus, even when the period for performing automatic unload of two or more vehicles overlap, the passengers who arrive at the airport parking lot first can use the vehicles in order. Therefore, it is possible to avoid situations where vehicles are staying at getting on/off area of the airport parking lot.

### BRIEF DESCRIPTION OF DRAWINGS

FIG. 1A is a diagram for explaining an outline of a vehicle unloading management device according to a first embodiment;

FIG. 1B is another diagram for explaining the outline of the vehicle unloading management device according to the first embodiment;

FIG. 2 is a block diagram illustrating a configuration example of the vehicle unloading management device according to the first embodiment;

FIG. 3A is a diagram for explaining a specific example of the vehicle unloading management device according to the first embodiment;

FIG. 3B is another diagram for explaining the specific example of the vehicle unloading management device according to the first embodiment;

FIG. 3C is another diagram for explaining the specific example of the vehicle unloading management device according to the first embodiment;

FIG. 4A is a diagram for explaining a specific example of the vehicle unloading management device according to the first embodiment;

FIG. 4B is another diagram for explaining the specific example of the vehicle unloading management device according to the first embodiment;

FIG. 5 is a flowchart illustrating a process example of an information processing unit in the vehicle unloading management device according to the first embodiment;

FIG. 6A is a diagram for explaining a specific example of a vehicle unloading management device according to a second embodiment;

FIG. 6B is another diagram for explaining the specific example of the vehicle unloading management device according to the second embodiment; and

FIG. 6C is another diagram for explaining the specific example of the vehicle unloading management device according to the second embodiment.

### DESCRIPTION OF EMBODIMENT

A vehicle unloading management device and a vehicle unloading management device method according to an embodiment of the present disclosure will be described with reference to the appended drawings.

### 1. First Embodiment

### 1-1. Outline

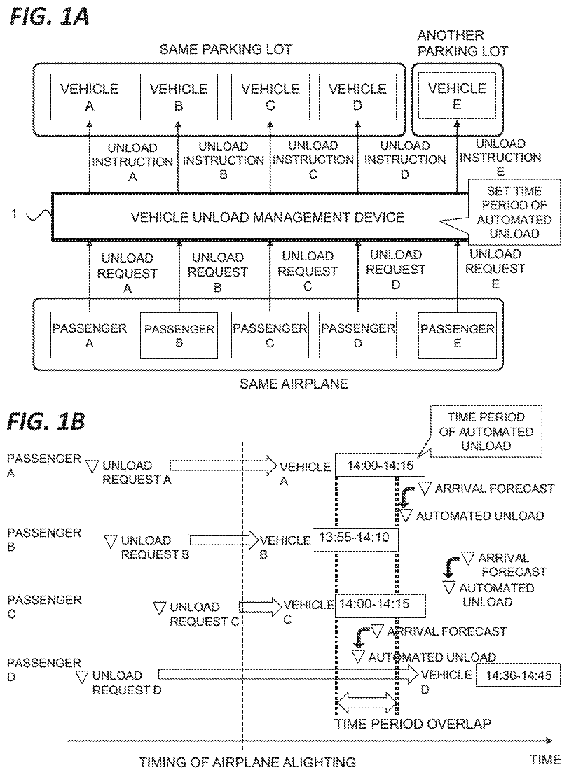

FIG. 1A and FIG. 1B is a diagram for explaining an overview of a vehicle unloading management device 1 according to the first embodiment. The vehicle unloading management device 1 is a device that manages unload of a vehicle that is parked in an airport parking lot. The vehicle loading the parking lot includes a vehicle used by a passenger of an airplane whose arrival destination is an airport after the passenger gets off the airplane. The vehicle may be a vehicle having an automated unload function. The vehicle having the automated unload function is, for example, an automated valet parking (AVP) vehicle. The AVP vehicle may be a vehicle that performs automatic driving or a vehicle that performs manual driving.

When an unload request is received from a passenger of an airplane before the airplane gets off, the vehicle unloading management device 1 sets a time period for performing automated unload of the vehicle of the passenger. The unload request includes a desired boarding time. The desired boarding time is input by the passenger at the time of the unload request. The desired boarding time input by the passenger is exemplified by 20 minutes after the airplane arrival time, 14:00 to 14:15, and the like. The time period for automated unload may be, for example, a time period set based on the desired boarding time or a time period predicted based on the flight information (estimated arrival time) of the airplane. The passenger can change the unload request before the passenger gets off the airplane. The time period for automated unload is set, for example, after a predetermined time has elapsed since the passenger deplaning.

A case where the vehicle unloading management device 1 receives at least two unload requests from some of the passengers of the same airplane will be considered. In this case, the vehicle unloading management device 1 sets a time period for performing automated unload on at least two vehicles corresponding to at least two unload requests. In the example shown in FIG. 1A, when unload requests (unload request A, unload request B, unload request C, unload request D, and unload request E) are received from passengers A, B, C, D, and E who are some of the passengers of the same airplane, time periods for automated unload are set for vehicles (vehicle A, vehicle B, vehicle C, vehicle D, and vehicle E) corresponding to the unload requests.

When the current time is in a time period for automated unload, the vehicle unloading management device 1 issues an unload instruction to a vehicle corresponding to the time period. The unload instruction means an instruction to park a vehicle loading a parking lot at getting on/off area of the parking lot.

Here, a case is considered where some of passengers of the same airplane are users of the same parking facility, and a time period for performing automated unload is set in accordance with at least two unload requests received from these passengers. In this case, it is assumed that the time periods for performing the automated unload overlap. For example, as illustrated in FIG. 1A, it is assumed that a vehicle A used by a passenger A, a vehicle B used by a passenger B, a vehicle C used by a passenger C, and a vehicle D used by a passenger D are parked in the same parking lot. Further, it is assumed that the time periods for automated unload set in accordance with the unload requests received from the passengers are, for example, 14:00 to 14:15 (time period for automated unload of vehicle A), 13:55 to 14:10 (time period for automated unload of vehicle B), 14:00 to 14:15 (time period for automated unload of vehicle C), and 14:30 to 14:45 (time period for automated unload of vehicle D), as shown in FIG. 1B. At this time, the time periods for performing the automated unload of the vehicle A, the vehicle B, and the vehicle C overlap.

Therefore, the vehicle unloading management device 1 predicts the arrival order in which the passengers corresponding to the unload requests for which the time periods for performing the automated unload overlap arrive at getting on/off area of the parking lot. The vehicle unloading management device 1 determines the order of automated unload of vehicles according to the arrival order. For example, as illustrated in FIG. 1B, when the arrival order of the passengers at the parking lot is predicted to be the order of the passenger C, the passenger A, and the passenger B, the automated unload is performed in the order of the vehicle C, the vehicle A, and the vehicle B. In FIG. The arrival order of passengers at getting on/off area of the parking facility will be described in detail later.

### 1-2. Specific Example

### 1-2-1. Configuration Example

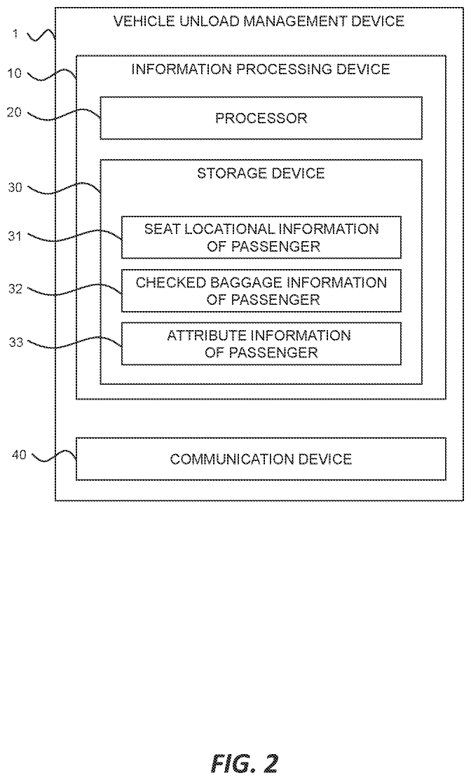

FIG. 2 is a block diagram showing a configuration example of the vehicle unloading management device 1 according to the first embodiment. The vehicle unloading management device 1 includes an information processing unit 10 and a communication device 40.

The information processing unit 10 is a computer that executes at least a process of setting a time period for automated unload of a vehicle used by a passenger. The information processing unit 10 includes one or more processors 20 (hereinafter, simply referred to as a processor 20) and one or more storage devices 30 (hereinafter, simply referred to as a storage device 30). The processor 20 executes various processes. As the processor 20, a central processing unit (CPU) is exemplified. The storage device 30 stores various kinds of information necessary for processing by the processor 20. Examples of the memory device 30 include a volatile memory, a non-volatile memory, a hard disk drive (HDD), and a solid state drive (SSD).

The various information stored in the storage device 30 includes seat locational information 31 of the passenger, checked baggage information 32 of the passenger, attribute information 33 of the passenger, and a vehicle unloading management program (not shown). The passenger attribute information 33 includes information on the presence or absence of a predetermined age (a young child or an elderly person), information on the presence or absence of a disabled person, and the like. The passenger's seat locational information 31, the passenger's checked baggage information 32, and the passenger's attribute information 33 are, for example, registered information of passengers managed by airlines.

The vehicle unloading management program is a computer program executed by the processor 20. The processor 20 executes the vehicle unloading management program, thereby realizing the functions of the information processing unit 10. The vehicle unloading management program may be stored in the storage device 30, may be stored in a memory built in the processor 20, or may be recorded in a computer-readable recording medium.

The communication device 40 communicates with the outside of the vehicle unloading management device 1. For example, the communication device 40 communicates with a terminal used by a passenger of an airplane or a vehicle used by a passenger.

### 1-2-2. Prediction Example of Arrival Order

As described above, the vehicle unloading management device 1 predicts the arrival order based on at least two unload requests for which the time periods for performing automated unload overlap. Specifically, the vehicle unloading management device 1 predicts a required time required for the passenger to move to getting on/off area of the parking lot after the passenger gets off the airplane based on at least one of the seat locational information 31 of the passenger, the checked baggage information 32 of the passenger, and the attribute information 33 of the passenger corresponding to the unload request. The vehicle unloading management device 1 predicts the arrival order according to the required time. The required time is a time obtained by adding a delay time from the shortest time to the shortest time required for the passenger to move to getting on/off area of the parking facility after the passenger gets off the airplane. The minimum time is a time set in advance in response to an alighting area of the airplane. The shortest time is expressed by 10 minutes or the like. That is, the delay time is predicted based on at least one of the passenger's seat locational information 31, the passenger's checked baggage information 32, and the passenger's attribute information 33. The shortest time is a time at which the delay time is 0 [min]. The details of an example of the prediction of the delay time will be described below.

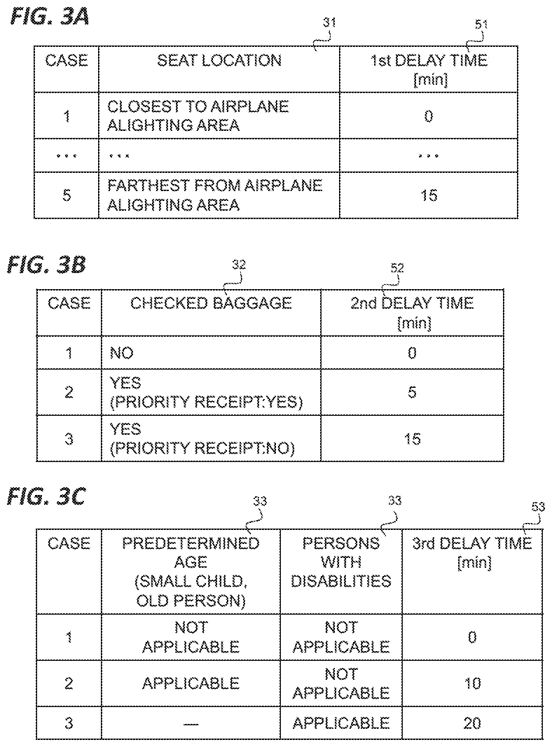

FIG. 3A, FIG. 3B, and FIG. 3C is a diagram for explaining a specific example of the vehicle unloading management device 1 according to the first embodiment. Specifically, FIG. 3A, FIG. 3B, and FIG. 3C illustrates details of an example of prediction of a delay time used for prediction of an arrival order in which passengers arrive at getting on/off area of a parking lot. Here, a factor of the delay time will be considered. The delay time includes a first delay time 51, a second delay time 52, and a third delay time 53. That is, the delay time (total delay time 60) is represented by the total value of the first delay time 51, the second delay time 52, and the third delay time 53.

The first delay time 51 is predicted based on the seat locational information 31 of the passenger. For example, as shown in FIG. 3A, the first delay time 51 becomes shorter as the seat location of the passenger is closer to the alighting area of the airplane and becomes longer as the seat location is farther from the alighting area of the airplane.

In the example illustrated in FIG. 3A, as illustrated in Case 1, when the seat location is closest to the alighting area of the airplane, the first delay time 51 is 0 [min]. On the other hand, as shown in Case 5, when the seat location is farthest from the alighting area of the airplane, the first delay time 51 is 15 [min]. That is, when the vehicle unloading management device 1 predicts the arrival order based on only the first delay time 51, the passenger at the seat location close to the alighting area of the airplane arrives earlier than the passenger at the seat location far from the alighting area.

The second delay time 52 is predicted based on the custody information 32 of the baggage of the passenger. For example, as shown in FIG. 3B, the second delay time 52 is shortened when there is no storage of a parcel and is lengthened when there is storage of a parcel. Further, the second delay time 52 is shortened when a checked baggage is present and the preferential reception of the baggage is present, and the second delay time 52 is lengthened when the checked baggage is present and the preferential reception of the baggage is not present. Information on whether or not the baggage is preferentially received is included in the checked baggage information 32 of the passenger.

In the example illustrated in FIG. 3B, as illustrated in Case 1, when there is not the checked baggage, the second delay time 52 is 0 [min]. On the other hand, as shown in case 2, when the checked baggage is present and the priority reception of the baggage is present, the second delay time 52 is 5 [min]. As shown in Case 3, when the checked baggage is present and the preferential reception of the baggage is not present, the second delay time 52 is 15 [min]. That is, when the vehicle unloading management device 1 predicts the arrival order based only on the second delay time 52, the passenger who has the checked baggage arrives later than the passenger who has not the checked baggage. Further, among passengers who have received baggage, a passenger who does not receive baggage with priority arrives later than a passenger who has received baggage with priority.

The third delay time 53 is predicted based on at least one of the presence or absence information of a predetermined age (a young child or an elderly person) and the presence or absence information of a disabled person included in the attribute information 33 of the passenger. For example, as shown in FIG. 3C, the third delay time 53 is shortened when the passenger or the passenger's companion is of a predetermined age and is lengthened when the passenger or the passenger's companion is not of a predetermined age. The third delay time 53 is shortened when the passenger or the passenger's companion is not a disabled person and is lengthened when the passenger or the passenger's companion is a disabled person.

In the example illustrated in FIG. 3C, as illustrated in Case 1, when the passenger or the passenger's companion is any one of a small child, an elderly person, and a disabled person, the third delay time 53 is 0 [min]. As shown in Case 2, when the passenger or the passenger's companion is a small child or an elderly person, the third delay time 53 is 10 [min]. Furthermore, as shown in Case 3, when the passenger or the passenger's companion is a disabled person, the third delay time 53 is 20 [min]. That is, in a case where the vehicle unloading management device 1 predicts the arrival order based on only the third delay time 53, when the passenger or the passenger's companion is any one of a small child, an elderly person, and a disabled person, the arrival order is later than that of a passenger who is not any one of them.

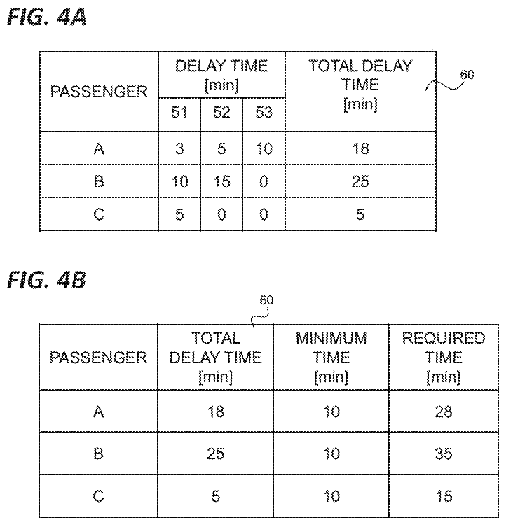

FIG. 4A is a diagram showing an example of calculation of the total delay time 60 for each passenger. For example, in the passenger A, when the first delay time 51 is 3 [min], the second delay time 52 is 5 [min], and the third delay time 53 is 10 [min], the total delay time 60 of the passenger A is 18 [min]. The total delay time 60 of the passenger B and the total delay time 60 of the passenger C are calculated by the same method as the total delay time 60 of the passenger A. In the example illustrated in FIG. 4B, the total delay time 60 of the passenger B is 25 [min], and the total delay time 60 of the passenger C is 5 [min].

FIG. 4B is a diagram illustrating an example of calculation of the required time for each passenger. In the example illustrated in FIG. 4B, when the shortest time is 10 [min], the required time of the passenger A is 28 [min], the required time of the passenger B is 35 [min], and the required time of the passenger C is 15 [min]. In this case, the arrival order of the passengers at getting on/off area of the parking facility lot is the order of the passenger C, the passenger A, and the passenger B.

Then, the vehicle unloading management device 1 determines to perform automated unload in the order of the vehicle C, the vehicle A, and the vehicle B in accordance with the arrival order.

As first embodiment above, when the time periods for performing automated unload of two or more vehicles used by passengers of an airplane overlap, the vehicle unloading management device 1 according to the first embodiment predicts the order in which the passengers corresponding to the unload requests of these vehicles arrive at the parking facility. Then, the order of automated unload of two or more vehicles is determined according to the arrival order. Therefore, even when the time periods for performing automated unload of two or more vehicles overlap, the vehicles can be used in order from the passenger who arrived at the parking facility first. Therefore, it is possible to avoid a situation in which the vehicle stays at getting on/off area of the parking facility.

### 1-3. Processing Example

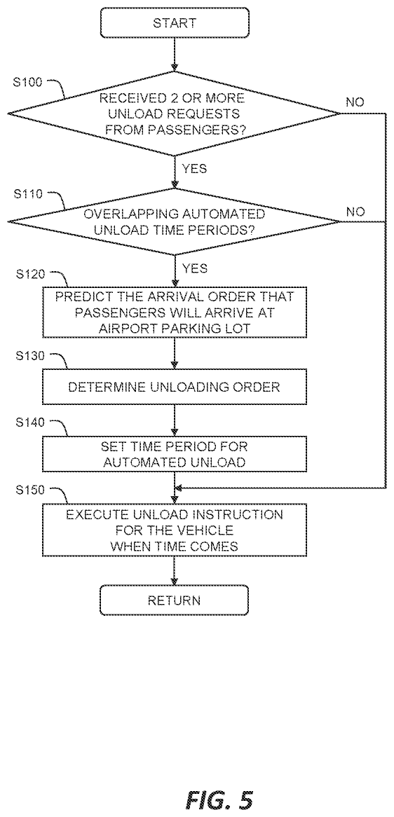

FIG. 5 is a flowchart illustrating an example of processing performed by the information processing unit 10 in the vehicle unloading management device 1 according to the first embodiment.

In step S100, the information processing unit 10 determines whether or not two or more unload requests have been received from the passenger before the deplaning. When it is determined that two or more unload requests have been received from the passenger before the deplaning (Yes in step S100), the process proceeds to step S110. Otherwise (No in step S100), the process proceeds to step S150.

In step S110, the information processing unit 10 determines whether or not the time periods for performing the automated unload set in accordance with the unload request overlap. When it is determined that the time periods for performing the automated unload overlap (Yes in step S110), the process proceeds to step S120. Otherwise (No in step S110), the process proceeds to step S150.

In step S120, the information processing unit 10 predicts the arrival order of the passengers at getting on/off area of the parking facility. Thereafter, the process proceeds to step S130.

In step S130, the information processing unit 10 determines an unloading order according to the arrival order. Thereafter, the process proceeds to step S140.

In step S140, the information processing unit 10 sets a time period of automated unload. Thereafter, the process proceeds to step S150.

In step S150, when the current time is in the time period of automated unload, the information processing unit 10 executes an unload instruction to the vehicles of the passengers.

### 2. Second Embodiment

According to the vehicle unloading management device 1 of the second embodiment, the unload request received from the passenger of the airplane further includes the post-getting-off facility usage schedule information 34 of the passenger. In the post-getting-off facility usage schedule information 34 of the passenger, when the passenger is scheduled to use the facility in the airport after getting-off, information such as facility use presence/absence information and facility use time period information is input by the passenger at the time of the unload request.

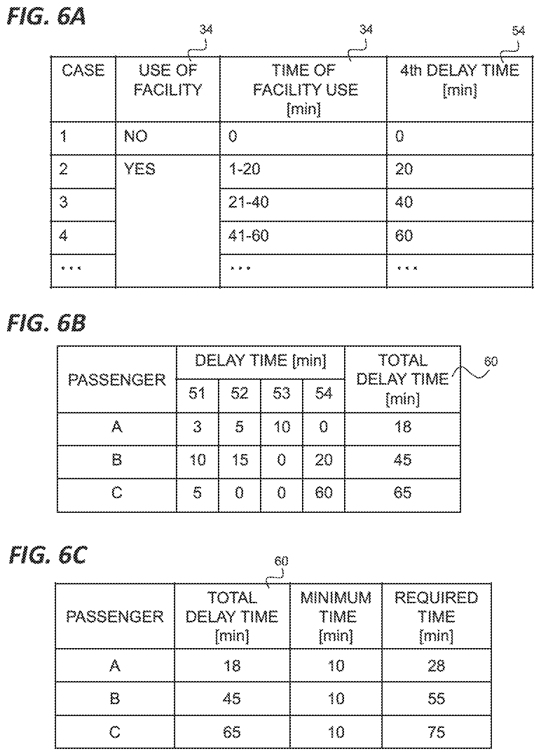

FIG. 6A, FIG. 6B, and FIG. 6C is a diagram for explaining a specific example of the vehicle unloading management device 1 according to the second embodiment. Specifically, FIG. 6A, FIG. 6B, and FIG. 6C illustrates details of a prediction example of the delay time used for predicting the arrival order in which the passengers arrive at getting on/off area of the parking facility. In the vehicle unloading management device 1 according to the second embodiment, the fourth delay time 54 is further included as a factor of the delay time. Therefore, the total delay time 60 is represented by the total value of the first delay time 51, the second delay time 52, the third delay time 53, and the fourth delay time 54.

The fourth delay time 54 is predicted based on, for example, at least one of the facility usage presence/absence information and the time period information of facility use included in the post-getting-off facility usage schedule information 34 of the passenger. In the example illustrated in FIG. 6A, the fourth delay time 54 is short when there is no use of the facility, and the fourth delay time 54 is long when there is use of the facility. Further, the fourth delay time 54 becomes shorter as the facility is used and the time period of the facility use is shorter, and the fourth delay time 54 becomes longer as the facility is used and the time period of the facility use is longer.

Specifically, as shown in Case 1 of FIG. 6A, when there is no use of the facility, the fourth delay time 54 is 0 [min]. On the other hand, as illustrated in Case 2 of FIG. 6A, when there is facility use and the time period of facility use input from the passenger at the time of the unload request corresponds to 1 to 20 [min], the fourth delay time 54 is 20 [min] that is the maximum value of the corresponding time period of facility use. The calculation is performed in the same manner as in the case 2 in the case 3 and the subsequent cases in FIG. 6A. Note that, in the example shown in FIG. 6A, the time period of facility use is divided into 20 minutes, but the time period is not limited thereto, and may be set as appropriate.

FIG. 6B is a diagram showing an example of calculation of the total delay time 60 for each passenger. For example, in the case where the first delay time 51 is 10 [min], the second delay time 52 is 15 [min], the third delay time 53 is 0 [min], and the fourth delay time 54 is 20 [min] for the passenger B, the total delay time 60 for the passenger B is 45 [min]. The total delay time 60 of the passenger A and the total delay time 60 of the passenger C are calculated by the same method as the total delay time 60 of the passenger B.

FIG. 6C is a diagram illustrating an example of calculation of the required time for each passenger. In the example illustrated in FIG. 6C, when the shortest time is 10 [min], the required time of the passenger A is 28 [min], the required time of the passenger B is 55 [min], and the required time of the passenger C is 75 [min]. In this case, the arrival order at getting on/off area of the parking facility lot is the order of the passenger A, the passenger B, and the passenger C.

Then, the vehicle unloading management device 1 determines to perform automated unload in the order of the vehicle A, the vehicle B, and the vehicle C in accordance with the arrival order.

As described above, according to the vehicle unloading management device 1 of the second embodiment, when a passenger inputs a facility usage schedule after deplaning at the time of an unload request, the arrival order is predicted based on the delay time in consideration of the facility use after deplaning. This further improves the accuracy of prediction of the arrival order. Therefore, it is possible to avoid a situation in which the vehicle stays at getting on/off area of the parking facility.

### 3. Other Embodiments

When passengers of the same airplane use vehicles parked in the same parking lot, it is expected that the vehicles are more likely to stay at getting on/off area of the parking lot in a time period in which the passengers automated unload of the vehicles without using facilities in the airport after deplaning than in a time period in which the passengers automated unload of the vehicles after using the facilities in the airport after deplaning. In this case, a privilege may be given to a passenger who uses a vehicle after the passenger uses a facility in the airport after disembarking as a cooperation with the reduction of the number of vehicles staying at getting on/off area of the parking facility lot.

According to the vehicle unloading management device 1 of another embodiment, when a passenger inputs a facility usage schedule after deplaning at the time of an unload request, privilege information (points or the like) is given to the passenger. The points given to the passenger may be set to be higher as the time period of the facility use is longer, for example.

What is claimed is:

1. A vehicle unloading management device for managing an unload of a vehicle parked in an airport parking lot, the vehicle unloading management device comprising a processor,
wherein the processor is configured to:
when an unload request for unloading a vehicle being loaded in the airport parking lot is received from a passenger of an airplane whose arrival destination is the airport, set a time period for performing automated unload of the passenger's vehicle;
in the process of setting the time period, when at least two unload requests are received from at least two vehicles and time periods for performing automated unload of the at least two vehicles overlap, predict an arrival order at the airport parking lot of passengers corresponding to the at least two unload requests with overlapping the time periods; and
determine an order for automated unload of the at least two vehicles according to the arrival order.

2. The vehicle unloading management device according to claim 1, further vehicle unloading management device comprising a storage device storing a seat locational information of passengers the airplane, a checked baggage information of the passengers, and attribute information of the passengers,
wherein the arrival order is predicted based on at least one of the seat locational information, the checked baggage information, and the attribute information on the passengers corresponding to the at least two unload requests with overlapping the time periods.

3. The vehicle unloading management device according to claim 1,
wherein when the at least two unload requests with overlapping the time periods include a facility usage schedule after the passenger gets off the airplane, the arrival order is predicted based on the facility usage schedule.

4. A vehicle unloading management method for managing an unload of a vehicle parked in an airport parking lot,
wherein the vehicle unloading management method comprises:
when an unload request for unloading a vehicle being loaded in the airport parking lot is received from a passenger of an airplane whose arrival destination is the airport, setting a time period for performing automated unload of the passenger's vehicle;
in the process of setting the time period, when at least two unload requests are received from at least two vehicles and time periods for performing automated unload of the at least two vehicles overlap, predicting an arrival order at the airport parking lot of passengers corresponding to the at least two unload requests with overlapping the time periods; and
determining an order for automated unload of the at least two vehicles according to the arrival order.
